(19) United States
(12) Patent Application Publication
(10) Pub. No.: US 2004/0261642 A1
(43) Pub. Date: Dec. 30, 2004

(54) Device for powdering printed sheets

(76) Inventor: Gunter Hess, Reutlingen (DE)

Correspondence Address: Dreiss Fuhlendorf, Steimle & Becker, Postfach 10 37 62, Stuttgart, D-70032, DE

(21) Appl. No.: 10/500,132

(22) PCT Filed: Jul. 28, 2003
(86) PCT No.: PCT/EP03/08307

(30) Foreign Application Priority Data
Nov. 28, 2002 (DE) 102 56 320.9

(51) Int. Cl. B41F 1/00

(52) U.S. Cl. 101/419

(57) ABSTRACT

The invention concerns a device for dusting printed sheets, which is disposed between the last printing or finishing unit of a printing machine and a print delivery device, comprising one or more nozzles for blowing powder onto the sheet and a conveyor cylinder which moves the sheet to be dusted past the nozzles, wherein the conveyor cylinder is disposed directly after the printing or finishing unit such that the sheet is directly received from the printing or finishing unit.

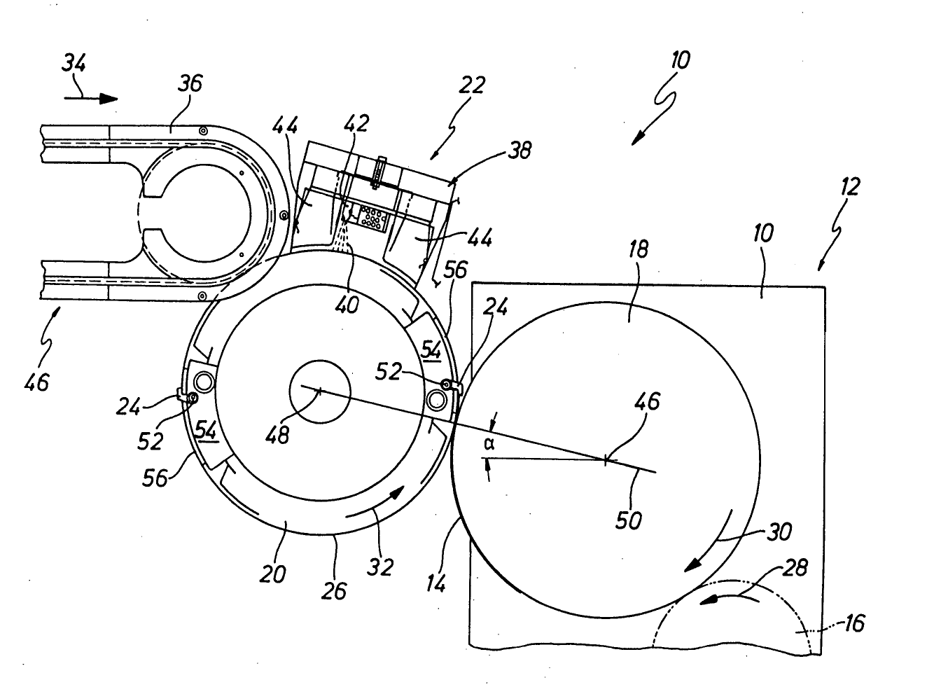

The invention concerns a device for dusting printed sheets, which is disposed between the last printing or finishing unit of a printing machine and a print delivery device, comprising one or more nozzles which blow powder onto the sheet, and a conveyor cylinder for moving the sheet to be dusted past the nozzles.

A device of this type is disclosed e.g. in DE 196 09 438 A1. In this device, the last printing mechanism of the printing machine delivers the printed sheet to an endless conveyor whose grippers are mounted to circulating chains. This endless conveyor is located in a sheet delivery device, in which the sheets are stacked in a sheet pile. The sheets are previously dusted with a powder. Towards this end, the endless conveyor transfers the newly printed sheet to a conveyor cylinder where the sheet is dusted with powder via nozzles. After the dusting process, the sheet is received by an endless conveyor and stacked. This device has the essential advantage that the sheet is not dusted on the chain conveyor with its high gripper beams, rather on a conveyor cylinder. For this reason, the nozzles can be mounted at a small separation from the sheet surface. The grippers holding the sheet are almost completely immersed in the conveyor cylinder and only slightly project past the sheet surface. The device is, however, particularly disadvantageous in that the sheet must be handled several times and two endless conveyors must be provided.

Departing from DE 196 09 438 A1, it is the underlying purpose of the present invention to provide a device of less complicated construction which still provides optimum dusting of the sheet.

This object is achieved in a device having the features of the pre-characterizing part in that the conveyor cylinder is disposed directly after the printing or finishing unit such that the sheet is directly received from the printing or finishing unit.

In the inventive device, the newly printed sheet is transferred directly to the conveyor cylinder by the last station of the printing machine which may either be a printing unit or a finishing unit, e.g. a lacquering unit, a punching, grooving or perforating unit or the like, without interposing an endless conveyor, e.g. a chain conveyor or the like. This is advantageous in that the nozzles discharging the powder can be disposed in the direct vicinity of the surface of the newly printed sheet, since no disturbing tall grippers are present. Nearly no vagabond powder migrates to the last station of the printing machine, since dusting is not carried out directly on the last cylinder of the last station. The inventive device is also much shorter since the endless conveyor, which is usually provided between the printing unit and the conveyor cylinder, can be omitted.

In a further development, the printing or finishing unit has a transport cylinder and the conveyor cylinder is disposed directly after this transport cylinder. Transfer occurs between two cylinders such that the gripper technology provided in the printing machine can be used for gripping and transporting the printed sheets.

The axes of the transport cylinder and of the conveyor cylinder are preferably substantially in a horizontal plane which might be slightly inclined. This is particularly advantageous in that the nozzles discharging the powder are provided in an upper region of the conveyor cylinder and do not have to be disposed on the side of the conveyor cylinder as in prior art. Access is facilitated in case of repair or replacement and there is more space for the entire dusting unit.

Optimum integration of the inventive unit in the printing machine is obtained through control by the printing or finishing unit or the printing machine. In addition to electric or electronic control, the drive is also direct or via a separate drive motor which is controlled by the printing machine.

The conveyor cylinder conventionally comprises at least one receptacle for the sheet grippers, which extends in its longitudinal direction, such that the individual grippers only slightly project past the grasped sheet. In accordance with the invention, the receptacle is largely sealed by a sealing element which prevents the powder, which is blown onto the sheet, from being whirled up and dragged in the direction of the printing or finishing unit. Moreover, the sheet runs more smoothly and feeding of the sheet at the conveyor cylinder is improved. Finally and advantageously, the excess powder can be more effectively suctioned off from the surface of the conveyor cylinder since it has a smoother surface and powder is not deposited in depressions or openings.

The curvature of the sealing element advantageously corresponds to the curvature of the shell of the conveyor cylinder. The sealing element is e.g. a curved shell segment which has slits for penetration of the grippers. This sealing element may consist of plastic material or metal (cover sheet) and can be disposed over the receptacle to close same in alignment with the shell of the conveyor cylinder. The sealing element thereby follows the shape of the shell of the conveyor cylinder to prevent swirling.

In another alternative as well as additional embodiment, the powder-discharging nozzles are disposed behind a slit diaphragm which opens when a sheet to be dusted is present. In this variant, which is known e.g. from DE 197 07 157 A1, the path between the nozzles and the surface of the conveyor cylinder is free only when a sheet to be dusted is present. As soon as the rear edge of the sheet passes the nozzles, the slit diaphragm closes and excess powder is retained and can be suctioned off. The slit diaphragm is thereby in close proximity to the sheet surface.

Further advantages, features and details of the invention can be extracted from the dependent claims and the following description which describes in detail a particularly preferred embodiment with reference to the drawing. The features shown in the drawing and mentioned in the claims and in the description may be essential to the invention either individually or in arbitrary combination.

The drawing shows a cross-section through the inventive device wherein the printing machine is only indicated and only part of the sheet delivery device is shown.

10 denotes the schematically shown last printing unit of a printing machine 12, wherein a printed sheet 14, which is only schematically shown, is transferred from a printing cylinder 16 to a transport cylinder 18 such that it can be received by a conveyor cylinder 20 of a device, referred to in total with 22, for dusting printed sheets 14. Grippers 24 are provided towards this end, which only slightly project past the shell surface 26 of the conveyor cylinder 20. The shell surface 26 forms the feed surface for the printed sheet 14. The arrows 28, 30 and 32 show the directions of rotation of the cylinders 16, 18 and 20, whereas the arrow 34 shows the transport direction of a chain conveyor 36. When the printed sheet 14 has been received by the conveyor cylinder 20, the latter is guided past a dusting unit 38 which sprays powder 40 onto the surface of the printed sheet 14. Suction devices 44 are provided on both sides of the nozzles 42 for suctioning off excess powder 40 to prevent vagabond powder from entering into the printing unit 10 or into the sheet delivery device 46, a component of which is the chain conveyor 36.

As is clearly shown, the axes 46 and 48 of the transport cylinder 18 or conveyor cylinder 20 are disposed in one plane 50 which is only slightly inclined relative to the horizontal.

The angle of inclination α of the plane 50 may be between 0° and ±20⁰. This orientation of the conveyor cylinder 20 provides sufficient space above the conveyor cylinder 20 for disposing the dusting unit 38. This dusting unit 38 can be easily accessed from the top.

The diameter of the conveyor cylinder 20 permits provision of grippers 24 on opposite sides, which can therefore receive two printed sheets 14 with one rotation. The grippers 24 are mounted to a gripper shaft 52 which is disposed in a receptacle 54. This receptacle 54 is overlapped by a sealing element 56 which is e.g. a profiled sheet. The curvature of the sealing element 56 is selected such that its outside continuously merges into the shell surface 26. The sealing element 56 only has slits through which the grippers 24 penetrate. The sealing element 56 can be unscrewed and removed e.g. for maintenance.

1-8. cancelled

9. A device for dusting a printed sheet, the device being disposed between a last printing or finishing unit of a printing machine and a print delivery device, the device comprising:
one or more nozzles for blowing powder onto the sheet; and a conveyor cylinder which moves the sheet to be dusted past said nozzles, wherein said conveyor cylinder is disposed and structured to received the sheet directly from the printing or finishing unit.

10. The device of claim 10, wherein the printing or finishing unit has a transport cylinder and said conveyor cylinder is disposed directly after that transport cylinder.

11. The device of claim 10, wherein axes of the transport cylinder and of said conveyor cylinder lie substantially in a horizontal plane.

12. The device of claim 9, wherein the device is controlled by one of the printing or finishing unit and the printing machine.

13. The device of claim 9, wherein said conveyor cylinder has at least one receptacle for a sheet gripper, said receptacle extending in a longitudinal direction of said conveyor cylinder, wherein said receptacle is substantially sealed by a sealing element.

14. The device of claim 13, wherein a curvature of said sealing element corresponds to a curvature of an outer surface of said conveyor cylinder.

15. The device of claim 13, wherein said sealing element follows the shape of an outer surface of said conveyor cylinder.

16. The device of claim 9, wherein said nozzles are disposed behind a slit diaphragm, wherein said slit diaphragm opens when the sheet to be dusted is present.
